(19) United States
(12) Patent Application Publication
(10) Pub. No.: US 2017/0157582 A1
(43) Pub. Date: Jun. 8, 2017

(54) SPRAY DRYING MIXED BATCH MATERIAL FOR PLASMA MELTING

(71) Applicant: Corning Incorporated, Corning, NY (US)

(72) Inventors: Irene Mona Peterson, Elmira Heights, NY (US); John Forrest Wight, Corning, NY (US); Jennifer Anella Heine, Horseheads, NY (US)

(21) Appl. No.: 15/322,599

(22) PCT Filed: Jun. 30, 2015
(86) PCT No.: PCT/US15/38568

§ 371 Date: Dec. 28, 2016

Related U.S. Application Data
(60) Provisional application No. 62/020,390, filed on Jul. 2, 2014.

(51) Int. Cl. B01J 2/02; C03B 19/10

(52) U.S. Cl. CPC B01J 2/02; C03B 19/1005

(57) ABSTRACT

A method of preparing a stable slurry of particles of glass precursors for spray drying and subsequent melting, such as by plasma melting, comprising grinding all constituent particles down to less than 50 microns in size, more desirably down to less than 25 or even less than 20 microns in size, removing the water from, or reducing the water content of the particles, mixing the particles with a liquid polymer binder and dispersant at a solids loading in the range of from 20-30%, more particularly in the range of from 22-27%, more desirably 24% by volume.

### CROSS-REFERENCE TO RELATED APPLICATIONS

This application claims the benefit of priority under 35 U.S.C. §119 of U.S. Provisional Application Ser. No. 62/020,390 filed on Jul. 2, 2014, the content of which is relied upon and incorporated herein by reference in its entirety.

### TECHNICAL FIELD

The disclosure relates generally to glass manufacturing and methods and, more particularly, to glass methods including spray drying of mixed batch material, followed by plasma melting.

### BACKGROUND

Plasma melting of finely divided glass precursors as a method to produce glass is known. Preparation of agglomerates of glass precursors for plasma melting by spray drying is known. Typical preparation of slurries for spray drying relies upon adjustment of the pH of the particle slurry in order to provide a degree of electrostatic repulsion between particles.

### SUMMARY

A method is disclosed of preparing a stable slurry of particles of glass precursors for later spray drying. The method may, and desirably does, include grinding all constituent particles, desirably down to less than 50 microns in size, more desirably down to less than 25 or even less than 20 microns in size. This increases the stability of the resulting suspension. Further the method includes removing the water from, or reducing the water content of the particles, for at least for those particles that are hygroscopic and/or those that form hydroxides. Then the particles are mixed with a liquid polymer binder and dispersant, desirably by first mixing these into water, then adding the particles and mixing to form a slurry. The dispersant helps prevent agglomeration of the particles before spray drying, while the binder dries during spray-drying to hold the agglomerates together. The solids loading of the slurry is desirably in the range of from 20-30%, more particularly in the range of from 22-27%, most desirably 24% by volume. This method is then able to produce, upon spray drying, a generally spherical agglomerate with the mode of the agglomerate particle being 100 micrometers or less, desirably around 50 micrometers plus or minus 10, more desirably plus or minus 5.

### BRIEF DESCRIPTION OF THE DRAWINGS

These and other aspects are better understood when the following detailed description is read with reference to the accompanying drawings, in which:

FIG. 1 shows an example of a desirable particle distribution of the glass constituents prior to formation of the slurry;

FIG. 2 is an electron micrograph of one embodiment of agglomerates produced by the disclosed and described process;

FIG. 3 shows an example of a desirable particle distribution of the agglomerates produced after spray drying and before plasma melting to produce glass;

FIG. 4 is an SEM backscatter image showing a polished cross section of a compositionally uniform plasma melted sphere produced by plasma melting of spray dried spheres produced by processes according to the present disclosure;

FIG. 5 is an SEM backscatter image showing a similarly prepared compositionally non-uniform plasma melted sphere produced by alternative processes.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

It would be useful to have a method to make individual agglomerates less than 100 microns in size which contained a mixture of raw batch materials, well distributed and in correct proportion, useful to make glasses such as Eagle XG® glass, including silica, alumina, SrCO₃, CaCo₃, B₂O₃, MgO and SnO₂.

Agglomerates are often prepared by spray drying. In order to spray dry the batch, a uniform, dispersed suspension should be prepared containing all the batch materials. Typically this is done with by adjustment of the pH so that its value is far from the isoelectric point. However, the batch materials used in the batch for Eagle XG® glass and some other glasses have a relatively wide variety of isoelectric points, as seen from the values (taken from the literature) in Table I below, so that it is not practical to prepare a uniform, well-performing slurry using this method. This disclosure describes and discloses a method for preparing and stabilizing the mixed-component slurry useful for mixtures of components such as these, and successfully spray drying it into spherical agglomerates of the desired size range.

TABLE I

| | Material | | | | | | |
|---|---|---|---|---|---|---|---|
| | Silicon | | | | Calcium | Strontium | Tin (IV) |
| | Dioxide | Alumina | Boric Acid | Magnesia | Carbonate | Carbonate | Oxide |
| | (SiO2) | (Al2O3) | (H3BO3) | (MgO) | (CaCO3) | (SrCO3) | (SnO2) |
| pH at the | 1.7-3.5 | 7-8 | <7 | 12-13 | 9.25-10 | <7 | 4-5.5 |
| isoelectric | | | | | | | |
| point in water | | | | | | | |

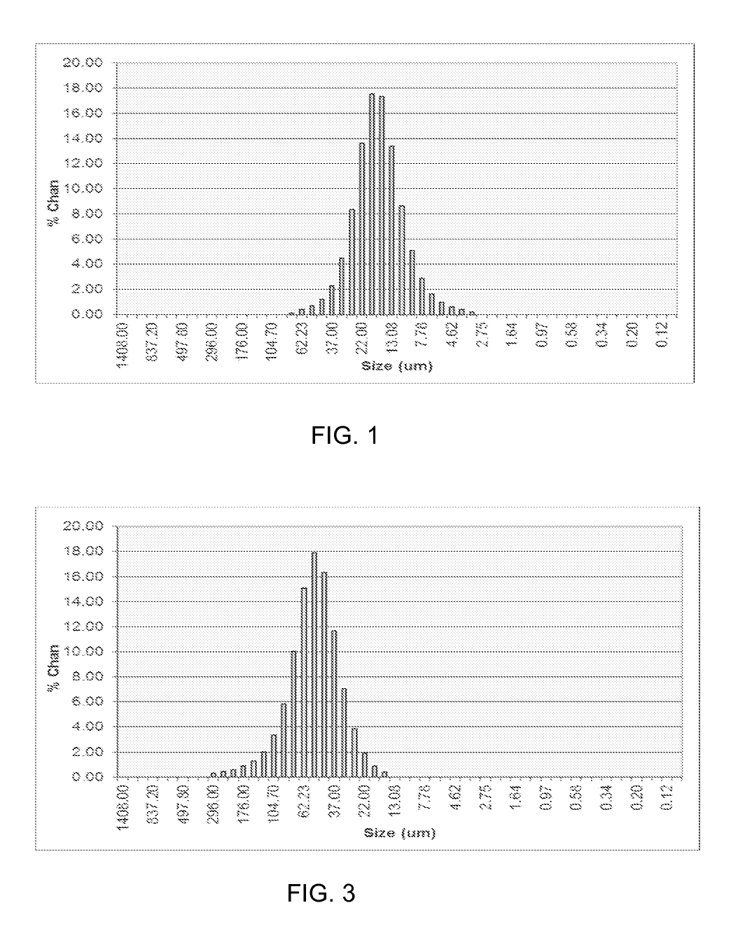

The disclosed method of preparing the stable slurry involves grinding the particles down at least to less than 50 micrometers, desirably to less than 25 micrometers or even less that 20 micrometers in size. This increases the particles' stability in suspension. Referring to FIG. 1, an example of an embodiment of a desirable particle size distribution is shown, useful as the starting particle size for the disclosed process. The particles are dried, or at least those that form hydroxides or are otherwise hygroscopic. In the experimental example herein, they were dried in a hot air dryer at 90 ° C. for between 5 hours and 10 hours.

Next, water is desirably mixed or stirred and a liquid polymer-based binder and a dispersant are added to the water while it is mixed or stirred. Then the solids are slowly added to the liquid while continuously mixing or stirring in order to coat the particles with a layer of polymer dispersant to provide steric hindrance against agglomeration before spray drying, and to coat the particles also with a binder material that dries during the spray-drying process to hold the spray-dried agglomerates together. A solids loading of the slurry is desirably in the range of from 20-30%, more particularly in the range of from 22-27%, more desirably about 24%. In the experimental example herein, water was mixed in a beaker using a mixer starting at 500 RPM, and then 5 wt % liquid polymer-based binder (styrene acrylic copolymer such as Duramax B1022) and 0.045 wt % dispersant (ammonium salt acrylic polymer such as Duramax D3005) were added to the water while mixing. Then the solids were slowly added to the liquid for a total of 10000 grams of slurry at 24% particle loading by volume, all while continuously stirring, at up to 1200 RPM after particle addition, in order to coat the particles with a uniform layer of polymer dispersant to provide steric hindrance against agglomeration before spray drying, and to coat with a binder that dries during the spray-drying process to hold the spray-dried agglomerates together.

The slurry is then spray dried, desirably at an outlet temperature of from 100 to 120° C., experimentally at 104° C., and desirably at an inlet temperature of from 250 to 350° C., experimentally at 300° C., and desirably at an atomizing pressure of 1 bar +/- 20%, desirably +/−10%, experimentally and nominally 1 bar. A GEA Mobile Minor spray drier with a fountain two-fluid nozzle system was used.

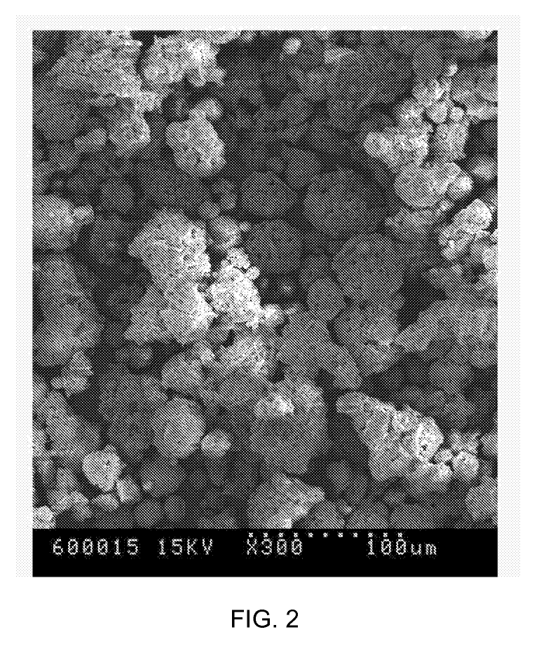

FIG. 2 is an electron micrograph of the resulting spherical agglomerates.

FIG. 3 is a graph of the agglomerate size distribution, with the mode of the agglomerate particle 100 micrometers or less at around 50 micrometers plus or minus 5, or 10. Plasma melting of the produced agglomerate has been shown to be able to form Eagle XG® glass spheres in the size range of nanometers to micrometers.

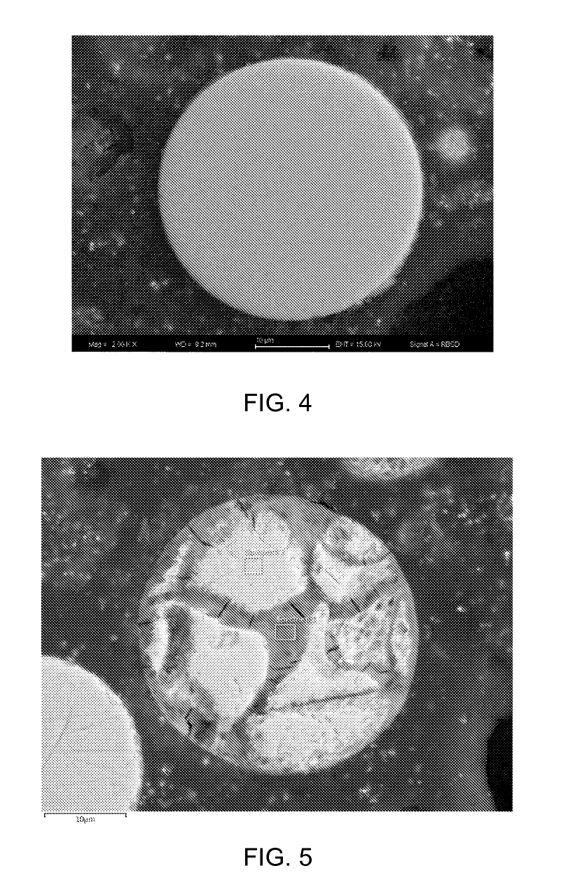

FIG. 4 is an SEM backscatter image showing a compositionally uniform plasma melted sphere produced by plasma melting of spray dried spheres produced by processes according to the present disclosure. The uniform spheres so produced are useful to produce bulk glass objects of all shapes and forms, such as by molding, sintering, 3D printing and the like.

FIG. 5 is an SEM backscatter image showing a compositionally non-uniform plasma melted sphere produced by plasma melting of spray dried spheres produced by alternative processes.

It will be apparent to those skilled in the art that various modifications and variations can be made to the present disclosure without departing from the spirit and scope of the subject matter claimed.

1. A method of preparing a stable slurry of particles of glass precursors for spray drying, the method comprising:
grinding precursor particles to less than 50 micrometers in size;
removing the water from, or reducing the water content of, the particles; and
mixing the dried particles with a liquid polymer binder and a liquid dispersant to form a slurry.

2. The method according to claim 1 wherein the step of grinding comprises grinding all precursor particles to less than 25 micrometers in size.

3. The method according to claim 1 wherein the step of grinding comprises grinding all precursor particles to less than 20 micrometers in size.

4. The method according to claim 1 wherein the step of mixing comprises first mixing a liquid polymer binder and a liquid dispersant into water, then adding the particles and mixing to form the slurry.

5. The method according to claim 1 wherein the step of mixing further comprises mixing in proportion to achieve a solids loading of the slurry in the range of from 20-30% by volume.

6. The method according to claim 1 wherein the step of mixing further comprises mixing in proportion to achieve a solids loading of the slurry in the range of from 22-27% by volume.

7. The method according to claim 1 wherein the step of mixing further comprises mixing in proportion to achieve a solids loading of the slurry of about 24% by volume.

8. The method according to claim 1 further comprising the step of spray drying the slurry.

9. The method according to claim 8 wherein the step of spray drying comprises spray drying at an outlet temperature in the range of from 100 to 120° C.

10. The method according to claim 8 wherein the step of spray drying comprises spray drying at an outlet temperature of 104° C.

11. The method according to claim 8 wherein the step of spray drying comprises spray drying at an inlet temperature in the range of from 250 to 350° C.

12. The method according to claim 8 wherein the step of spray drying comprises spray drying at an inlet temperature of 300° C.

13. The method according to claim 8 wherein the step of spray drying comprises spray drying at an atomizing pressure of 1 bar +/−20%.

14. The method according to claim 8 wherein the step of spray drying comprises spray drying at an atomizing pressure of 1 bar +/−10%.

15. The method according to claim 8 wherein the step of spray drying comprises spray drying at an atomizing pressure of 1 bar.
